(19) United States
(12) Patent Application Publication
(10) Pub. No.: US 2002/0186108 A1
(43) Pub. Date: Dec. 12, 2002

(54) Micro electromechanical switches

(76) Inventor: Paul Hallbjorner, Goteborg (SE)

Correspondence Address: NIXON & VANDERHYE P.C., 8th Floor, 1100 North Glebe Road, Arlington, VA, 22201, US

(21) Appl. No.: 10/112,051

(22) Filed: Apr. 1, 2002

(30) Foreign Application Priority Data
Apr. 2, 2001 (SE) 0101184-0

(51) Int. Cl. H01H 51/22

(52) U.S. Cl. 335/78

(57) ABSTRACT

A micro electromechanical N-way switch comprising normally open micro electromechanical switches and normally closed micro electromechanical switches arranged in up to 2^{C} rows with C columns of a logical functions matrix. Each row of predetermined serially coupled micro electromechanical switches will create, when selected, a signal path to one way of the N-way switch. The micro electromechanical switches are commonly controlled column by column. Also a phase shift arrangement is shown, with a limited predetermined number of micro electromechanical switches in the signal path, irrespective of the number of selectable phase shift elements.

### TECHNICAL FIELD

The invention concerns micro electromechanical switches and more particularly to micro electromechanical switch circuits.

### BACKGROUND

Micro electromechanical switches are used in a variety of applications up to the microwave frequency range. A micro electromechanical switch is usually a beam with support at one or both ends. The support will normally either extend above a substrate surface or be level with the substrate surface, i.e. a micro electromechanical switch is normally built on top of the substrate surface or into the substrate. The beam acts as one plate of a parallel-plate capacitor. A voltage, known as an actuation voltage, is applied between the beam and an actuation electrode, the other plate, on the switch base. In the switch-closing phase, or ON-state, for a normally open switch, the actuation voltage exerts an electrostatic force of attraction on the beam large enough to overcome the stiffness of the beam. As a result of the electrostatic force of attraction, the beam deflects and makes a connection with a contact electrode on the switch base, closing the switch. When the actuation voltage is removed, the beam will return to its natural state, breaking its connection with the contact electrode and opening the switch. A basic micro electromechanical switch is a single pole single throw switch. A selection of different elements in a signal path, such as a choice of a phase shift or not, traditionally involves a phase shift element and a bypass element and four micro electromechanical switches, one for each element as entry switch and one for each element as an exit switch. If a choice of more elements is desired, these are added in series in the same manner. The signal paths will then have to pass through a plurality of micro electromechanical switches, each of which induces a loss. This loss, due to the switches, is usually undesirable and there therefore seems to be room for improvement.

### SUMMARY

An object of the invention is to define a manner to select different signal paths, with a low loss, in high frequency circuits by means of micro electromechanical switches.

Another object of the invention is to define a switching circuit which implements an N-way switch with micro electromechanical switches in a predictable efficient low loss manner.

A further object of the invention is to define a switching circuit signal path control arrangement to be able to practically implement an N-way micro electromechanical switching circuit.

A still further object of the invention is to limit the necessary substrate real estate for an N-way micro electromechanical switching circuit.

Still another object of the invention is to minimize the necessary number of control lines to an N-way micro electromechanical switch.

The aforementioned objects are achieved according to the invention by a micro electromechanical N-way switch comprising normally open micro electromechanical switches and normally closed micro electromechanical switches arranged in up to 2^{C} rows with C columns of a logical functions matrix. Each row of predetermined serially coupled micro electromechanical switches will create, when selected, a signal path to one way of the N-way switch. The micro electromechanical switches are commonly controlled column by column.

The aforementioned objects are also achieved according to the invention by a phase shift arrangement with a limited predetermined number of micro electromechanical switches in the signal path, irrespective of the number of selectable phase shift elements.

The aforementioned objects are achieved according to the invention by a switching circuit and a switching circuit signal path control arrangement therefor comprising a plurality of micro electromechanical switches each having a signal path with a first connection at one end of the signal path and a second connection at the other end of the signal path, and at least two control lines controlling the micro electromechanical switches. The micro electromechanical switches are at least two normally open micro electromechanical switches each having an active signal path when activated, and at least two normally closed micro electromechanical switches each having an active signal path when not activated. According to the invention the micro electromechanical switches are arranged in a logical function matrix comprising at least two rows and two columns. On a row by row basis the first connections of micro electromechanical switches of a first column are signal connections at a first side of the logical function matrix and second connections of micro electromechanical switches of a last column are signal connections at a second side of the logical function matrix. The signal paths of the micro electromechanical switches are serially coupled on a row by row basis. The control lines controlling the micro electromechanical switches are coupled to the micro electromechanical switches on a column by column basis with one control line per column. The micro electromechanical switches arranged in a column of the logical function matrix are commonly controlled by a single control line. This constitutes the switching circuit signal path control arrangement. Thereby the signal paths of the switching circuit are controlled with a number of control lines being less than the number of micro electromechanical switches.

Suitably the maximum number of rows with micro electromechanical switches of the virtual matrix is limited to 2^{C}, where C is the number of columns of the virtual matrix. The normally open micro electromechanical switches and the normally closed micro electromechanical switches can be arranged in predetermined sequences in each row, where each row comprises a unique predetermined sequence. In some applications the connections of the first side of the virtual matrix are coupled together, making a demultiplexer switching circuit. In other applications the connections of the second side of the virtual matrix are coupled together, making a multiplexer switching circuit.

The aforementioned objects are achieved according to the invention by a phase shift arrangement comprising a number of selectable phase shift elements. According to the invention the selectable phase shift elements are selected by means of a switching circuit and a switching circuit signal path control arrangement according to any above described embodiment.

By providing a micro electromechanical switching circuit according to the invention a plurality of advantages over prior art micro electromechanical switching circuit are obtained. Primary purposes of the invention are to provide a reduced requirement of substrate real estate when constructing N-way switches with micro electromechanical switches and also to provide a well defined number of micro electromechanical switches in the signal path, irrespective of N. Other advantages of this invention will become apparent from the detailed description.

### BRIEF DESCRIPTION OF THE DRAWINGS

The invention will now be described in more detail for explanatory, and in no sense limiting, purposes, with reference to the following figures, in which

FIGS. 1A-1C shows a cross section of different micro electromechanical switches,

FIG. 2 shows a traditional serially coupled phase shift arrangement with micro electromechanical switches,

FIG. 3 shows a phase shift arrangement with micro electromechanical switches according to one aspect of the invention,

FIG. 4 shows a four-way switch with micro electromechanical switches according to the invention.

### DETAILED DESCRIPTION

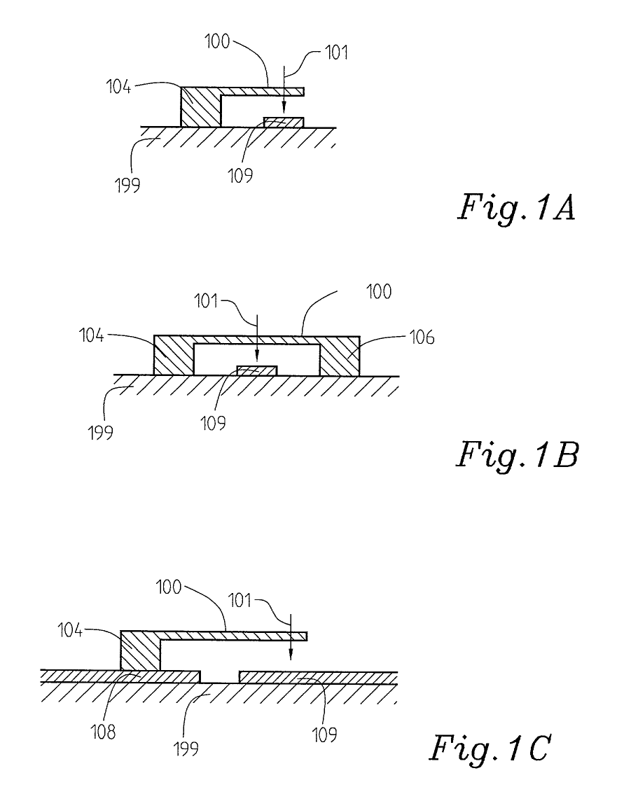

In order to clarify the method and device according to the invention, some examples of its use will now be described in connection with FIGS. 1a to 4.

As is shown in FIG. 1, a micro electromechanical system (MEMS) switch comprises a beam 100 supported either by one support 104 as is shown in FIGS. 1A and 1C, or by two supports 104, 106 as is shown in FIG. 1B. A MEMS switch can be manufactured to either look somewhat as illustrated in FIG. 1, with the support 104 or supports 104, 106 being on top of a substrate 199, i.e. protruding from the substrate 199, in which case the substrate 199 coincides with a base of the switch. Or a MEMS switch can be manufactured by creating a depression in the substrate under the beam, which is then supported at one or both ends by the surrounding substrate. The base of the switch will in these MEMS switches not coincide with the substrate, but be located at the bottom of the depression under the beam.

FIG. 1A shows a basic cantilever type MEMS switch with a beam 100 held in place by a single support 104. A signal electrode 109 possibly combined with an actuation electrode is placed underneath the beam 100 on the switch base, which in this type coincides with the substrate 199. When an actuation voltage is applied between the actuation electrode and the beam 100, a force 101 on the beam 100 will cause it to move in the direction of the force 101 onto the signal electrode 109.

FIG. 1B shows a basic bridge type MEMS switch with a beam 100 being supported by two supports 104, 106, one at each end of the beam 100. The basic functioning is otherwise the same as that of the basic cantilever type.

The actuation electrode 109 in MEMS switch are often combined with the signal electrode, especially in these types and when utilized with high frequencies, the commonly used DC voltage as actuation voltage is then easily separated from the signal. A single pole single throw switch can be classified into two basic types, the normally open (NO) and the normally closed (NC). The normally open will not conduct any signal from its input to its output when in its resting state, i.e. when there is no actuation voltage present. The normally open will only conduct a signal from its input to its output when in its active state, i.e. when there is an actuation voltage present. The normally closed will conduct a signal from its input to its output when in its resting state, but not when in its active state. A MEMS switch can accomplish these different types in a number of ways.

A normally open MEMS switch can be accomplished by dividing a signal electrode directly underneath a beam, i.e. creating a gap in the signal electrode, such that a conductive surface underneath the beam is able to overbridge the gap when the MEMS switch is active. When the MEMS switch is inactive the signal path is broken and when the MEMS switch is active the signal path is complete.

A normally closed MEMS switch can be accomplished by having at least a part of the beam that comes into contact with a signal electrode, being conductive to ground. When the MEMS switch is inactive, the signal path is complete and will thus transmit any desired signals. When the MEMS switch is active, the signal electrode will be grounded, thus breaking the signal path.

Both the MEMS switch according to FIG. 1A and the MEMS switch according to FIG. 1B illustrate MEMS switch types where the signal electrode 109 is perpendicular to the extension of the MEMS switch, i.e. the extension of the beam 100. FIG. 1C shows a MEMS switch type where the extension of the signal electrode 108, 109 coincides with the extension of the MEMS switch. The illustrated MEMS switch according to FIG. 1C is of the normally open type. Here the signal electrode is divided into a first signal electrode 108 and into a second signal electrode 109. The first signal electrode 108 is connected to a conductive part of the support 104. The conductive part should at least extend onto the beam 100 far enough, so that when a force 101 displaces the beam 100 onto the second signal electrode 109, the conductive part makes contact with the second signal electrode 109.

In some circuits there is a desire to be able to redirect a signal to a plurality of different paths or to select a signal from a plurality of sources. There is a need to use multiple-way switches. Multiple-way switches constructed with micro electromechanical switches can easily become a very complex matter. Traditionally multiple-way switches using MEMS switches have been constructed in a serial fashion, i.e. each element in the signal path has had its own by pass, and each such group has been located one after the other along the signal path.

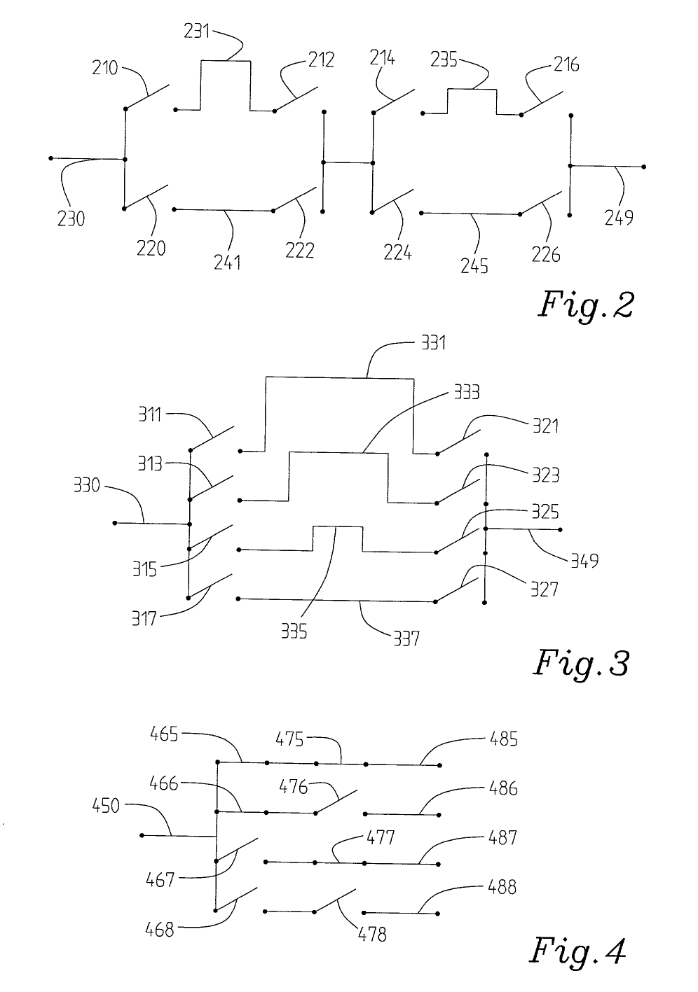

FIG. 2 illustrates a traditional serially coupled phase shift arrangement with micro electromechanical switches 210, 212, 214, 216, 220, 222, 224, 226. The phase shift arrangement comprises two sections. The first section comprises the signal entry 230 to the phase shift arrangement, a first phase shift element 231 and a first bypass 241. These elements 231, 241 are selectively coupled into the signal path by either entry MEMS switch 210 and exit MEMS switch 212 of the first phase shift element 231 or by entry MEMS switch 220 and exit MEMS switch 222 of the first bypass 241. The signal is thereafter led to the second section after having passed two MEMS switches and either the first phase shift element 231 or the first bypass element 241. The second section comprises a second phase shift element 235 and a second bypass 245. These elements 235, 245 are selectively coupled into the signal path by either entry MEMS switch 214 and exit MEMS switch 216 of the second phase shift element 235 or by entry MEMS switch 224 and exit MEMS switch 226 of the second bypass 245. The signal path from signal entry 230 to signal exit 249 has to pass through four MEMS switches 210, 212, 214, 216, 220, 222, 224, 226, and two elements 231, 235, 241, 245. For a signal to have to pass through four MEMS switches can still be acceptable, but every section adds another two MEMS switches into the signal path. There is usually no signal headroom for extending this type of signal path selection by the addition of two MEMS switches in the signal path for every additional selection.

FIG. 3 shows a phase shift arrangement with micro electromechanical switches according to one aspect of the invention. This phase shift arrangement comprises one bypass element 337 and three different phase shift elements 331, 333, 335. Each element 331, 333, 335, 337 is selected by a pair of MEMS switch, one respective entry MEMS switch 311, 313, 315, 317 and one respective exit MEMS switch 321, 323, 325, 327. The entry MEMS switches 311, 313, 315, 317 are coupled together at the signal entry 330, and the exit MEMS switches 321, 323, 325, 327 are coupled together at the signal exit 349. If a selectable element is of a single ended type, then only a respective entry MEMS switch is required. A phase shift arrangement or other type of arrangement of this type will only require a signal to pass through two MEMS switches, irrespective how many selections there are. All the elements that can be chosen are electrically located in parallel, each element requires two MEMS switches, one entry MEMS switch and one exit MEMS switch. One end of each MEMS switch is connected to a respective end of the element that is to be selectable, the other end of the entry MEMS switch is connected to other entry MEMS switch and a signal entry, and the other end of the exit MEMS switch is connected to other exit MEMS switch and a signal exit. This type of arrangement is excellent for small selection arrangements, because each selectable element requires its own control signal. For four selectable elements, as shown in the example according to FIG. 3, four control signals are required. The more selectable elements there are the more control signals are required. This will restrict the practical use of this type of selection arrangement since the necessary control signal will require too much real estate of the substrate.

A four-way switch (either with one input and four outputs, or four inputs and one output) as that of one side of FIG. 3 requires four MEMS switches, each one with its own control signal. Each MEMS switch of the switch needs to be controlled, because if one path is desired, the other paths must be disconnected, otherwise the constructed multiple way switch would exert an undesirable load on the rest of the circuit. An N-way switch needs N MEMS switches and N control signals, one for each MEMS switch. As mentioned, this would fill up the substrate with control signal electrodes and proper feeding.

FIG. 4 shows a four-way switch with micro electromechanical switches according to the invention. The N-way switch architecture of the invention utilizes two different types of MEMS switches to drastically reduce the number of necessary control signals with increasing N. This will save substrate real-estate, which can then be used either for other circuitry or the total size will be reduced thus reducing costs. The four-way switch according to FIG. 4 requires two control signals, both of which are in an inactive state, the result of which is shown in FIG. 4. A five- to eight-way switch requires three control signals, and a nine- to 16-way switch requires four control signals. The required number of control signals is equal to or the next higher integer of logN/log2, for an N-way switch. The saving on the required number of control signals is greater the larger the N-way switch. To enable this reduction in control signals, and as can be seen in FIG. 4, the invention uses a combination of normally open MEMS switches 467, 468, 476, 478 and normally closed MEMS switches 465, 466, 475, 477. The MEMS switches could be said to be arranged in a virtual or, perhaps more appropriately called, logical function matrix, comprising a number of rows equal to the number of selections, and a number of columns equal to the number of control signals. The number of desired selections, i.e. rows, will determine the number of required control signals, i.e. columns. Each row of MEMS switches will comprise a number of normally closed MEMS switches and/or normally open MEMS switches, each one in a separate column. The sequence of normally closed MEMS switches and/or normally open MEMS switches in every row, is normally different from the sequence of any other row. The only time a specific sequence is the same in more than one row, is when more than one row is to be selected at the same time, and thereby by the same control signals.

A specific sequence of MEMS switches will only allow an unbroken signal path to be set up for a specific set of actuation voltages on the control signals. FIG. 4 shows when both control signals are non-active, i.e. the actuation voltages relative the respective beam is in a non-active state, usually 0 volts. The first row, comprising two normally closed MEMS switches 465, 475 is the only unbroken signal path, and an electrical connection is made between the common input/output 450 and the signal input/output 485 of the first row. In this example the rows are counted from the top, one through four, and the columns are counted from the left, one and two. The first row comprises a normally closed MEMS switch 465 of the first column, a normally closed MEMS switch 475 of the second column, and an input/output 485. The MEMS switch 465 of the first column and the first row is connected at one end to the common input/output 450 and the other end to one end of the MEMS switch 475 of the second column and the first row, the other end of which is connected to the input/output 485 of the first row. The second row comprises a normally closed MEMS switch 466 of the first column, a normally open MEMS switch 476 of the second column, and an input/output 486. The MEMS switch 466 of the first column and the second row is connected at one end to the common input/output 450 and the other end to one end of the MEMS switch 476 of the second column and the second row, the other end of which is connected to the input/output 486 of the second row. The third row comprises a normally open MEMS switch 467 of the first column, a normally closed MEMS switch 477 of the second column, and an input/output 487. The MEMS switch 467 of the first column and the third row is connected at one end to the common input/output 450 and the other end to one end of the MEMS switch 477 of the second column and the third row, the other end of which is connected to the input/output 487 of the third row. The fourth row comprises a normally open MEMS switch 468 of the first column, a normally open MEMS switch 478 of the second column, and an input/output 488. The MEMS switch 468 of the first column and the fourth row is connected at one end to the common input/output 450 and the other end to one end of the MEMS switch 478 of the second column and the fourth row, the other end of which is connected to the input/output 488 of the fourth row. In this example none of the rows have the same sequence of the two different types of MEMS switch, i.e. only one row at a time can be selected by the control signals. A first control signal will control the MEMS switch 465, 466, 467, 468 of the first column, and a second control signal will control the MEMS switch 475, 476, 477, 478 of the second column. A control signal will be designated active when it will cause its connected MEMS switch to change from their normal status, and a control signal will be designated inactive when the connected MEMS switch will remain in their normal status.

As mentioned before, FIG. 4 shows when both control signals are inactive, i.e. only the first row shows an unbroken signal path between the common input/output 450 and an input/output on the other side, in this case the input/output 485 of the first row. If the first control signal becomes active and, leaving the second control signal inactive, then only the third row will have an unbroken signal path. If on the other hand only the second control signal becomes active, the first control signal remaining inactive, then only the second row will have an unbroken signal path. Finally, if both control signals are active, then only the fourth row will have an unbroken signal path.

An N-way switch according to the invention can suitably be implemented in a phase shift arrangement as that according to FIG. 3, i.e. instead of the entry MEMS switches of FIG. 3 putting in a four-way switch according to FIG. 4 and instead of the exit MEMS switches of FIG. 3 putting in a mirrored four-way switch. A signal path will then always pass through four MEMS switches, which is two more than the two of the example according to FIG. 3. Having to pass through four MEMS switches will for most applications be acceptable, especially since this number will not increase with the number of desired selections, but will stay constant.

The basic principle of the invention is to reduce the necessary substrate real estate necessary for an N-way switch, by reducing the number of necessary control signals by means of combining normally open and normally closed MEMS switches specific sequences in rows in a logical function matrix.

The invention is not restricted to the above described embodiments, but may be varied within the scope of the following claims.

FIG. 1

| | |
|---|---|
| 100 | beam, |
| 101 | beam movement, |
| 104 | first beam support, |
| 106 | second beam support, |
| 108 | signal electrode, |
| 109 | actuation/signal electrode, |
| 199 | substrate/switch base. |

FIG. 2

| | |
|---|---|
| 210 | entry MEMS switch of first phase shift element, |
| 212 | exit MEMS switch of first phase shift element, |
| 214 | entry MEMS switch of second phase shift element, |
| 216 | exit MEMS switch of second phase shift element, |
| 220 | entry MEMS switch of first bypass element, |
| 222 | exit MEMS switch of first bypass element, |
| 224 | entry MEMS switch of second bypass element, |
| 226 | exit MEMS switch of second bypass element, |
| 230 | signal entry, |
| 231 | first phase shift element, |
| 235 | second phase shift element, |
| 241 | first bypass element, |
| 245 | second bypass element, |
| 249 | signal exit. |

FIG. 3

| | |
|---|---|
| 311 | entry MEMS switch of first phase shift element, |
| 313 | entry MEMS switch of second phase shift element, |
| 315 | entry MEMS switch of third phase shift element, |
| 317 | entry MEMS switch of bypass element, |
| 321 | exit MEMS switch of first phase shift element, |
| 323 | exit MEMS switch of second phase shift element, |
| 325 | exit MEMS switch of third phase shift element, |
| 327 | exit MEMS switch of bypass element, |
| 330 | signal entry, |
| 331 | first phase shift element, |
| 333 | second phase shift element, |
| 335 | third phase shift element, |
| 337 | bypass element, |
| 349 | signal exit. |

FIG. 4

| | |
|---|---|
| 450 | common signal input/output, |
| 465 | normally closed MEMS switch of first column and first row, |
| 466 | normally closed MEMS switch of first column and second row, |
| 467 | normally open MEMS switch of first column and third row, |
| 468 | normally open MEMS switch of first column and fourth row, |
| 475 | normally closed MEMS switch of second column and first row, |
| 476 | normally open MEMS switch of second column and second row, |
| 477 | normally closed MEMS switch of second column and third row, |
| 478 | normally open MEMS switch of second column and fourth row, |
| 485 | signal input/output of first row, |
| 486 | signal input/output of second row, |
| 487 | signal input/output of third row, |
| 488 | signal input/output of fourth row, |

1. A switching circuit and a switching circuit signal path control arrangement therefor comprising a plurality of micro electromechanical switches each having a signal path with a first connection at one end of the signal path and a second connection at the other end of the signal path, and at least two control lines controlling the micro electromechanical switches, the micro electromechanical switches being at least two normally open micro electromechanical switches each having an active signal path when activated, and at least two normally closed micro electromechanical switches each having an active signal path when not activated, characterized in that:
the micro electromechanical switches are arranged in a logical function matrix comprising at least two rows and two columns, on a row by row basis the first connections of micro electromechanical switches of a first column being signal connections at a first side of the logical function matrix and second connections of micro electromechanical switches of a last column being signal connections at a second side of the logical function matrix;
the signal paths of the micro electromechanical switches are serially coupled on a row by row basis;
the control lines controlling the micro electromechanical switches are coupled to the micro electromechanical switches on a column by column basis with one control line per column, the micro electromechanical switches arranged in a column of the logical function matrix being commonly controlled by a single control line, this constitutes the switching circuit signal path control arrangement;
thereby controlling the signal paths of the switching circuit with a number of control lines being less than the number of micro electromechanical switches.

2. The switching circuit and the switching circuit signal path control arrangement according to claim 1, characterized in that:
the maximum number of rows with micro electromechanical switches of the virtual matrix is limited to 2^{C}, where C is the number of columns of the virtual matrix.

3. The switching circuit and the switching circuit signal path control arrangement according to claim 1 or 2, characterized in that:
the normally open micro electromechanical switches and the normally closed micro electromechanical switches are arranged in predetermined sequences in each row;
each row comprises a unique predetermined sequence.

4. The switching circuit and the switching circuit signal path control arrangement according to any one of claims 1 to 3, characterized in that:
the connections of the first side of the virtual matrix are coupled together, making a demultiplexer switching circuit.

5. The switching circuit and the switching circuit signal path control arrangement according to any one of claims 1 to 3, characterized in that:
the connections of the second side of the virtual matrix are coupled together, making a multiplexer switching circuit.

6. A phase shift arrangement comprising a number of selectable phase shift elements, characterized in that the selectable phase shift elements are selected by means of a switching circuit and a switching circuit signal path control arrangement according to any one of claims 1 to 5.
